(19) United States
(12) Patent Application Publication
(10) Pub. No.: US 2002/0014618 A1
(43) Pub. Date: Feb. 7, 2002

(54) Jack accessory

(76) Inventor: Bruce L. Hawkins, Hereford, AZ (US)

Correspondence Address: Bruce L. Hawkins, 7882 East Highway 92, Hereford, AZ, 85615, US

(21) Appl. No.: 09/871,271

(22) Filed: May 31, 2001

Related U.S. Application Data
(60) Provisional application No. 60/209,852, filed on May 31, 2000.

(51) Int. Cl. B66F 1/04

(52) U.S. Cl. 254/111

(57) ABSTRACT

The invention provides jack accessories for expanding the ability of a jack. One embodiment is a jack accessory assembly having a lift column, a lift-column socket adapted to fit the lift-column, and a tongue adapted to fit in the lift-column socket. In another embodiment, the invention is a lift-column socket built as a rectangular tube having a first side adapted to receive support from a catching means, and a first flange-catch coupled to the front, the first flange-catch for supporting a flange of a tongue.

### CROSS REFERENCE TO RELATED APPLICATION

The invention is related to and claims priority from U.S. Provisional Pat. application Ser. No. 60/209,852, filed On May 31, 2000, by Bruce L. Hawkins, and entitled Universal Jack Extension.

### BACKGROUND OF THE INVENTION

1. Technical Field of the Invention

The invention relates generally to methods, systems, and devices, such as jacks, for lifting objects. More specifically, the invention relates to accessories for such methods, systems, and devices that that enhance their abilities. One preferred embodiment is more specifically an accessory for a universal jack extension that enhances the ability of the universal jack extension to lift, spread, or clamp.

2. Problem Statement

Lift jacks, or simply “jacks”, are used to lift objects and provide structural support. For example, most vehicles carry jacks that can be used to lift a portion of the vehicle so that a tire can be removed or to provide access to the underside of the vehicle. Farm vehicles frequently use jacks in the field for a variety of mechanical and lifting projects. In addition, jacks are commonly used to hold up a wall or ceiling while other, more permanent support pieces (such as columns) are constructed. Furthermore, Jacks have many other uses and applications that are well known in the art.

Some popular jacks are the “Hi-Lift,” “Handyman,” and “Lumberman.” FIG. 1 (prior art) is a general representation of one prior art jack embodiment.

The jack 100 of FIG. 1 generally includes a base 110 having a flat bottom 112, a stem 120 rigidly coupled to the base 110, whereby the stem 120 extends at a right angle to the bottom 112. In addition, the stem 120 has a channel 122 that extends throughout nearly all the length of the stem 120. In addition, the stem 120 has holes 124 that extend transversely through the stem 120. The jack 100 also has a stem-embracing lifting slide 130 that includes a lifting shoulder, a lever 134 pivoted on the lifting slide 130, a means responsive to reciprocation of the lever 134 for lifting the slide 130, step by step, along the stem 120, and a settable member. The settable member, in one position, makes the slide movement responsive to, and dependent on, lever operation. In another position, the settable member frees the slide 130 and the lever carried by it for movement relative to the stem and in unison with one another.

Often, a jack supporting means has a fixed upper mounting plate and a fixed lower mounting plate. Means are often provided for holding a stem firmly and securely to the lower mounting plate, and this often involves the use of a retaining plate that lies in a groove of the stem (and is covered to a substantial extent by the slide). The upper end of the stem and the lever are often firmly and fixedly clamped to the upper mounting plate in fixed relation to one another, and a key operated means is often provided for preventing relaxation of the clamping pressure. So long as the slide cannot move relative to the stem, the lower retaining plate remains covered and the connection to the lower mounting plate, as well as the connection to the upper mounting plate, remains intact. For holding the lever in fixed position alongside the stem, the upper holding plate is typically slotted to provide a “finger” that extends into the upper end of the hollow lever.

Jacks are frequently designed and built so that they can be placed in specific containers, or located in specific areas of a vehicle, rather than for the performance of a specific task. This has led to many jacks being built that are limited in their uses. Even when not limited due to a space-fitting design consideration, Jacks are often of limited use due to the design or construction of the Jack. For example, many farm jacks cannot support an overhead load. Likewise, there is frequently insufficient room to operate a jack's handle due to obstacles in the path of the handle. In addition, the jack's full range may be inaccessible due to the jack's range of motion being consumed before the jack's load is reached. Furthermore, the increments of a jack's load catches are often so large that a load cannot be precisely positioned or controlled. Fortunately, these problems are not frequently encountered. Unfortunately, when these problems do arise, a user may be required to purchase an entire new jack to lift a load. This can be an economically unattractive solution. Therefore, there exist the need for a method, system, and device that enables the controlled lifting of loads in a structurally sound manner. Preferably, the device is economical, and consumes little space.

### SUMMARY OF THE INVENTION

The invention provides technical advantages as methods and devices that expand the capabilities of a jack, such as a universal jack lift. The invention preferably fits a plurality of jacks, such as farm or Handy-Man jacks, is adjustable to provide ease of use from a plurality of access positions (from the front, left, or right of the jack), is extendable beyond the normal height of the standard jack, and provides for increased flexibility of positioning of the jack beyond the standard notch spacing. In addition, the invention preferably provides a safety-latch to prevent over-extension of the jack, and a handle retainer. Furthermore, additional features may be provided to the invention by incorporating a large base to increase jack stability, and wheels to provide for jack portability.

Accordingly, in one embodiment, the invention is a jack accessory assembly having a lift column, a lift-column socket adapted to fit the lift-column, and a tongue adapted to fit in the lift-column socket. In another embodiment, the invention is a lift-column socket built as a rectangular tube having a first side adapted to receive support from a catching means, and a first flange-catch coupled to the front, the first flange-catch for supporting a flange of a tongue.

In another embodiment the invention is a tongue for a jack accessory. The tongue includes a flange adapted to be received by a lift-column socket, and a support base rigidly coupled to the flange. In a preferred embodiment, the tongue also includes a catch disposed in the flange, where the catch adapted to be received by a catch-hole of a lift-column socket.

Of course, other features and embodiments of the invention will be readily apparent to those of ordinary skill in the art, and thus, similar results as described herein can be achieved in not dissimilar manners. Accordingly, the following discussion should not be read as limiting, and the scope of the invention should be read as limited only as defined in the CLAIMS.

### DESCRIPTION OF FIGURES

The invention is best understood by reference to the following detailed description, which should be read in conjunction with the accompanying drawings, wherein:

FIG. 1 (prior art) is a general representation of one prior art jack embodiment;

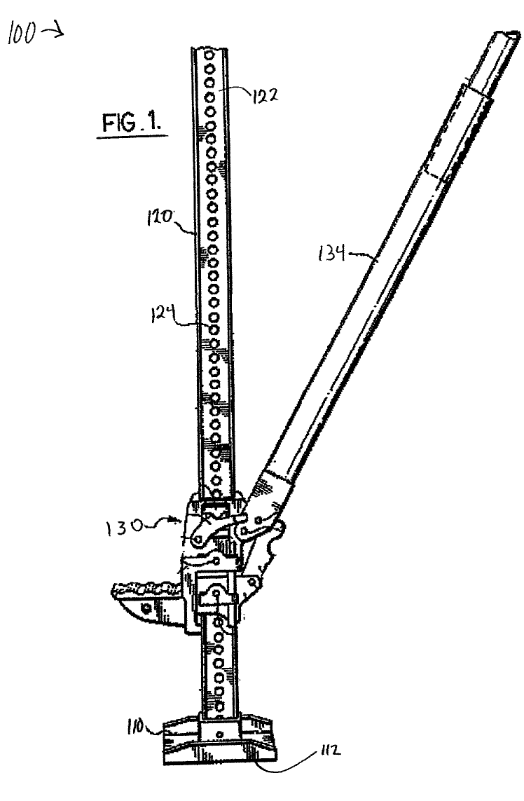

FIG. 2 shows one embodiment of the invention incorporated with a jack;

FIG. 3 illustrates a lift column;

FIG. 4 teaches a lift-column socket; and

FIG. 5 provides a tongue.

### DETAILED DESCRIPTION

The invention is, in one embodiment, a jack accessory for expanding the ability of a jack. One embodiment has a lift column, a lift-column socket adapted to fit the lift-column, and a tongue adapted to fit in the lift-column socket. Thus, the invention expands the capabilities of a jack, such as a universal jack lift. The invention preferably fits a plurality of jacks by sliding over, or fitting about, a jack stem. Preferably, the invention provides a tongue that may be placed on a plurality of sides of a lift column socket, so as to be adjustable to provide ease of use from a plurality of access positions (from the front, left, or right of the jack). In addition, the invention is preferably extendable beyond the normal height of the standard jack, and provides for increased flexibility of positioning of the jack beyond the standard notch spacing. Accordingly, the invention provides these and numerous other advantages that will be readily apparent from the teachings herein to those of ordinary skill in the art.

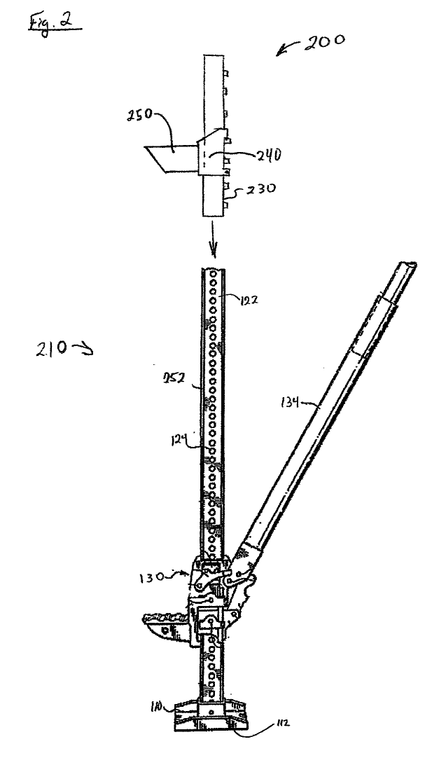

A jack accessory may be better understood by illustrating it in conjunction with a jack. Accordingly, FIG. 2 shows one embodiment of a jack accessory 200 incorporated with a jack 210. As can be seen, the jack accessory has a lift column 230 that fits about a jack stem (or “stem”) 252 of the jack 210. In addition to the lift column 230, the jack accessory also includes a lift-column socket 240 adapted to fit the lift-column, and a tongue 250 adapted to fit in the lift-column socket 240. In operation, the lift-column socket 240 is secured about the lift column 230, and the tongue 250 is secured in the lift-column socket 240. However, the lift-column socket 240 is preferably removable from the lift column 230, and is also able to travel the length of the lift column 230, and to be secured to the lift column 230 at a plurality of locations, as discussed below.

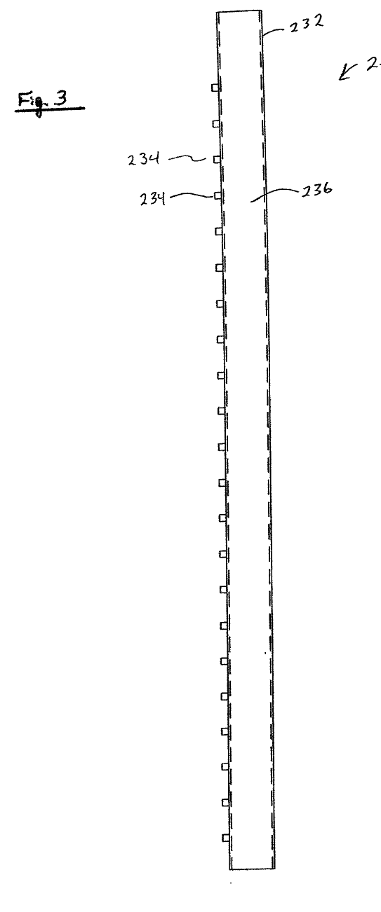

FIG. 3. more clearly illustrates a lift column 230. The lift column 230 comprises a rectangular tube 232 having a plurality of catching means 234 thereon. Preferably, and as illustrated in FIG. 3, the catching means 234 may be embodied as teeth. The lift column 230 has a cavity 236 (illustrated by the dashed lines) so that the lift column 230 is adapted to fit about a jack stem and rest on a jack runner. However, it should be understood that the lift column 230 need not be limited to a generally rectangular structure as illustrated in FIG. 3, but may be embodied in any configuration so long as it may be disposed about a jack stem, and support at least a tongue.

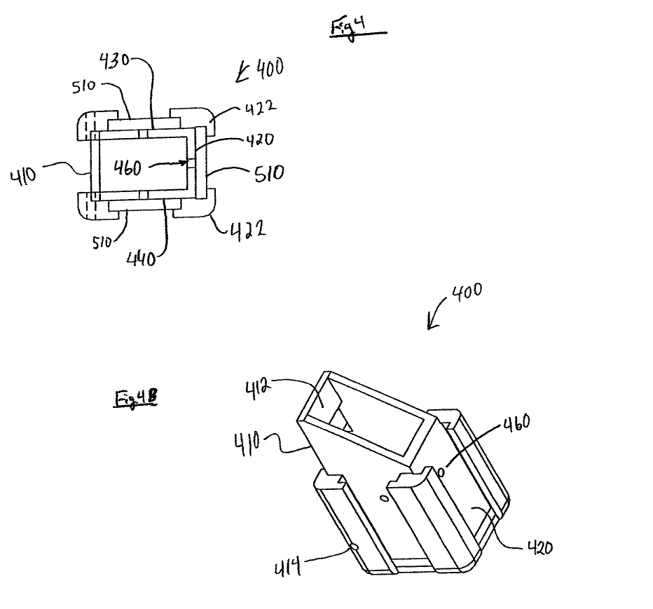

Additional value is provided to the invention by a lift-column socket, which can be secured along a lift column, and may be configured to accept a flange of a tongue. FIG. 4 teaches features of a lift-column socket 400. The lift-column socket 400 is typically embodied as a rectangular tube having a first side 410 adapted to receive, via a catching means such as a flange-catch, a flange from a tongue, a front 420 directly opposite the first side 410, a right side 430, and a left side 440. In one embodiment, a first flange-catch 422, which is for supporting a flange of a tongue, is coupled to the front 420. In another embodiment, the lift-column socket 400 provides a plurality of flange-catches coupled to the right side 430 and the left side 440. Preferably, the first side 410 includes a support bar 412 rigidly coupled between the left side 440 and the right side 430. In addition, it is preferable to provide a means for securing the lift-column socket 400 to a jack stem. In one embodiment, this may be accomplished by sliding a pin through securing holes 414 to provide lateral support to the lift-column socket 400, while a tooth or teeth of the lift column provide vertical support to the lift-column socket. When the jack accessory is in use, the support bar 412 rests on a tooth of a lift column, thus transferring the weight of a load from the lift column socket to the lift column. For this reason, the support bar 412 should be strong, and designed to carry at least the same load as the strongest jack it is associated with. To more effectively secure a tongue in the lift column socket 400, a catch-hole 460 is provided in the front 410.

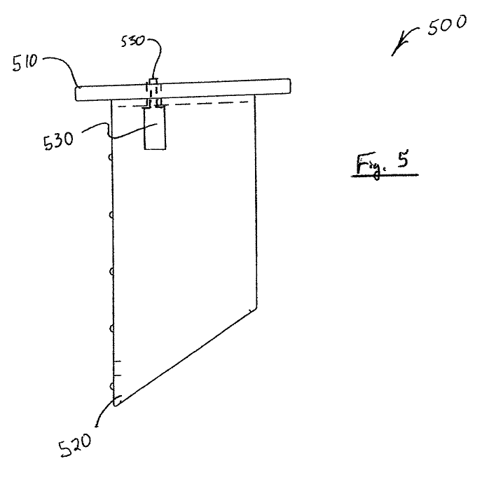

FIG. 5 provides a more detailed examination of a tongue 500. In a preferred embodiment, the tongue 500 includes a flange 510 adapted to be received by a lift-column socket, and a support base 520, such as a rectangular tube, rigidly coupled to the flange 510. The catch-hole 460 of FIG. 4 receives a catch 530 disposed in the flange 510. In a preferred embodiment, the catch 530 is spring-loaded. To operate a spring-loaded catch, a user need not do anything to secure the catch into a catch-hole. To release a spring-loaded catch, a user merely needs to pull on the spring-loaded catch to pull it out of the catch-hole, thus allowing the tongue to be removed from its lift-column socket. Of course, should a user desire, the tongue may be rigidly mounted to a lift-column socket.

Though the background section describes specific applications of a jack accessory, it should be understood that this is done for exemplary purposes only, and that the invention is in no way limited to the specific jack accessory disclosed herein (which is the best mode of the invention known to the inventor at the time of the submission of the patent application). Furthermore, it should be understood that the above discussion is merely a description of an embodiment, and that the invention is limited only by the following claims.

I claim:

1. A jack accessory assembly, comprising:
a lift column;
a lift-column socket adapted to fit the lift-column; and
a tongue adapted to fit in the lift-column socket.

2. The jack accessory of claim 1 wherein the lift-column socket is secured about the lift column.

3. The jack accessory of claim 1 wherein the tongue is disposed in the lift-column socket.

4. The jack accessory of claim 1 wherein the lift column comprises a rectangular tube having a plurality of catching means thereon.

5. The jack accessory of claim 1 wherein the lift column is adapted to fit about a jack stem and rest on a jack runner.

6. The jack accessory of claim 4 wherein the catching means comprises teeth.

7. A lift-column socket, comprising:
a rectangular tube having a first side adapted to receive support from a catching means, a front directly opposite the first side, a right side, and a left side; and
a first flange-catch coupled to the front, the first flange-catch for supporting a flange of a tongue.

8. The lift-column socket of claim 7 wherein the first side consist of a support bar coupled between the left side and the right side.

9. The lift-column socket of claim 7 further comprising a second flange-catch coupled to the right side.

10. The lift-column socket of claim 7 further comprising a third flange-catch coupled to the left side.

11. The lift-column socket of claim 7 further comprising a catch-hole in the front.

12. The lift-column socket of claim 7 further comprising a tongue disposed in the first flange-catch.

13. A tongue for a jack accessory, comprising:
a flange adapted to be received by a lift-column socket; and
a support base rigidly coupled to the flange.

14. The tongue of claim 13 further comprising a catch disposed in the flange, the catch adapted to be received by a catch-hole of a lift-column socket.

15. The tongue of claim 13 wherein the support base is a rectangular tube.

16. The tongue of claim 14 wherein the catch is spring-loaded.

17. The jack accessory assembly of claim 1 further comprising a pipe-support coupled to the lift column.

18. The jack accessory of claim 1 wherein the tongue is rigidly coupled to the socket.

19. The tongue of claim 13 further comprising a lift-column socket rigidly coupled to the flange.

20. The jack accessory of claim 1 further comprising a jack stem disposed in the lift-column.
